(19) United States
(12) Patent Application Publication
(10) Pub. No.: US 2004/0070757 A1
(43) Pub. Date: Apr. 15, 2004

(54) High viscosity sheath reagent for flow cytometry

(76) Inventors: Richard Channing Moore, Cambridge, MA (US); Anthony Ferrante, Belmont, MA (US)

Correspondence Address: Charles E Lyon, Choate Hall & Stewart, 53 State Street, Boston, MA, 02109, US

(21) Appl. No.: 10/203,841

(22) PCT Filed: Dec. 29, 2000
(86) PCT No.: PCT/US00/35543

(51) Int. Cl. G01N 21/00

(52) U.S. Cl. 356/339

(57) ABSTRACT

A flow cytometer for the analysis of large particles or small multicellular organisms may experience unstable flow because of the large diameter of the flow chamber. The use of a sheath fluid or a sheath and sample with addition of a viscosity-increasing agent to give a viscosity higher than that of water ensures that flow in the pre-analysis section will be fully developed laminar flow, and that the flow in the analysis section will be laminar. This allows accurate analysis and sorting of large particles or analysis and sorting of smaller particles at an increased rate of speed. Water-soluble polymers are preferred because they increase fluid velocity with negligible osmotic effects. A 0.9 weight % solution of polyvinyl pyrollidone with an average molecular weight of 1.3 million is particularly effective. Use of viscosity-increasing agents that cause minimal increases in surface tension of the fluid is also preferred.

The present application claims the priority and benefit of U.S. Provisional Patent Application 60/173,572 filed Dec. 29, 1999.

### BACKGROUND OF THE INVENTION

1. Field of the Invention

This invention pertains to a technology for counting and analysis of particles, generally called flow cytometry. Specifically, the invention deals with improvements which allow flow cytometry devices to: 1) handle large particles, including small elongate multicellular organisms, which are considerably larger than the particles on which flow cytometry machines are usually used, and/or 2) operate at significantly increased speeds.

2. Description of Related Art

Flow cytometry instruments optically analyze particles suspended in a fluid stream as the particles pass through a focussed light beam. The instruments use hydrodynamic focusing to center particles in the fluid stream. To ensure accurate and stable centering, the fluid flow must be fully laminar, with no oscillations or turbulence. Needless to say, any imperfections in the hydrodynamic focusing degrade the performance of the instrument. Imperfect hydrodynamic focusing results in flow instabilities, and optical measurements are predicated upon the analyzed particle passing at a constant velocity through the center of the optical beam. In the face of instabilities and imperfect focussing these assumptions are not met and the resulting optical data are erroneous.

In a typical flow cytometer, a sheath stream and sample fluid stream (containing suspended particles to be analyzed) are introduced into the flowcell in a pre-analysis section (chamber) of the flowcell. The sheath stream is injected into the flowcell and allowed to flow for a sufficient distance to form a fully developed laminar flow profile. The sample stream is injected into the center of this flow profile. The sample fluid is thus kept centered in the flow channel of the flowcell by the laminar sheath flow that includes a velocity differential between the sheath and the sample streams. The centered sample particles are analyzed as they pass through an “interrogation” station where a beam such as a laser beam traverses the flowcell and strikes the suspended particles one by one. Light emitted or scattered by the particles is received by one or more optical detectors that output optical data in response to the incident light.

If, for some reason, the sheath flow has not fully developed into a laminar flow, random oscillations may develop in the fluid, and in general, once any such oscillations have started they cannot be damped out. These instabilities destroy the measurement precision of the instrument. Previous inventors have had the objective of improving the flow characteristics in flow cytometers. Edens et al, U.S. Pat. No. 5,808,737, discloses several methods of modifying the geometry of a pre-analysis chamber to improve measurement accuracy and decrease sample line length. North, Jr., U.S. Pat. No. 4,790,653, discloses a pre-analysis chamber having a diverging taper to help maintain laminar sheath flow. There has been an emphasis on adjusting the geometry of the flow chamber and associated components to ensure laminar flow.

The problems due to defects in laminar flow are exacerbated at especially high flow rates and by large particles. High flow rates increase turbulence. To accommodate large particles the diameter of the flow channel must be enlarged. To some extent laminar flow is stabilized by interactions between the flowing fluid and the channel walls. As the channel is enlarged the distance between the walls and portions of the fluid stream is increased, thereby favoring instabilities.

Several prior art inventions have also been designed to analyze and sort large particles. Hansen et al, PCT/US99/19035, filed 20 Aug. 1999 and incorporated herein by reference, describes a method of sorting large particles and small multicellular organisms with flow cytometry principles by means of a fluid jet sorting mechanism. The flowcell and optics of this device are essentially similar to those of a typical flow cytometer. However, the diameter of the flow channel is increased to accommodate multicellular organisms such as nematodes and embryos of zebra fish and fruit flies. The typical laminar flow process not only centers the samples in the flow stream, it also orients the elongate organisms so that their long axis is parallel to the direction of flow. After the organisms pass through the laser beam and have their optical characteristics analyzed thereby, the fluid stream passes through a nozzle and becomes a solid sample stream in air (i.e., a continuous “solid” stream as opposed to a series of droplets).

The fluid stream is aimed into the well of a microtiter plate or other suitable receptacle. The entire fluid stream would be deposited in the well were it not for the “fluid switch”. The fluid switch consists of a separate stream of focussed fluid which strikes the stream in air just below the flow cell. The separate stream diverts the sample stream in air so that it goes to waste and does not enter the microtiter well. Because this intersection occurs below the flowcell, any shock waves or instabilities caused by the intersection are not transmitted upstream into the analysis region where they would spoil the analysis.

The “fluid switch” diverting fluid stream (control stream) is controlled by a high-speed fluidic valve. When electronic analysis of the particles passing through the laser beam indicates that a desirable organism is present, the high-speed valve is closed at the correct instant to cause a section of stream in air containing the organism to pass unimpeded into the microtiter well. Then, the high-speed valve is reopened once again to divert the sample stream in air and prevent additional fluid or organisms from entering the microtiter well. The microtiter tray is moved mechanically to bring another well into position to receive the stream in air, and the entire process is repeated to deposit a single desired organism in the well. In this way each of the wells of the microtiter tray receive a single selected organism.

FIG. 1 represents a simplified block diagram of such an instrument. A source of suspended multicellular sample organisms 20 flow into the flowcell 24 which is represented by a dotted line. Sheath fluid from a container 22 enters the flowcell 24 and laminar flow develops as discussed below. At a sensing zone (analysis region) 26 a laser beam (not shown) traverses the flow cell 24 and illuminates the organisms. Emitted and scattered light are received by optical detectors 28. The signals are analyzed by a computer 30. The computer output controls a fluidic valve 34 which switches fluid (i.e., compressed gas) from a source 36. A control stream 38 emerging from the valve 34 is aimed onto a sample stream in air 40 that emerges from the lower end of the flowcell 26 forming a deflected stream 42 which goes to waste. In actual practice the deflected stream may be a mist of droplets. When the sample stream 40 is not deflected, the stream and the organism therein lands in the well 44 of a microtiter plate 46.

Instruments of this design are sold commercially by Union Biometrica, Inc. as the COPAS Technology Platform.

In addition, Becton Dickinson and Company manufacture instruments, including the FACStar Plus and the FACScaliber, which are available with special flowcells with larger than normal flow channels. These instruments are intended for use with samples suspended in water, buffer or biological saline.

### SUMMARY OF THE INVENTION

The present inventors have found significant advantages to the use in flow-cytometry instruments of a sheath fluid with a viscosity significantly higher than that of water or biological saline. There are two primary situations where a viscous sheath is of especial advantage:

1) In the analysis and/or sorting of large particles, including small elongate multicellular organisms, without degradation of performance caused by instabilities in laminar flow;

2) In the analysis and/or sorting particles at a speed higher than could otherwise be achieved with a traditional flow cytometer;

The present inventors have found that increasing the viscosity of the sheath fluid dramatically decreases the flow length required to stabilize fully the flow.

This invention is critical for systems which require that the stream exit into air as a solid stream and not as droplets. If the flow rate is too slow, the stream will form droplets and drip out of the exit nozzle. The high-viscosity sheath allows these systems to be run at a flow rate sufficiently high that the fluid exits the nozzle as a solid stream rather than as a series of drops. An additional advantage of the high-viscosity sheath fluid is that large particles often settle out of the sample being analyzed before it reaches the flowcell. Increased viscosity of the sample fluid slows the rate at which the particles settle, making mixing of the samples easier and preventing settling in the sample lines. It should be kept in mind that if light scatter is used to detect and measure the particles, the sheath and sample fluid must have the same refractive index or the sample fluid will scatter light even when no particle is present. This means that modification of sheath viscosity will normally require a similar modification of the sample fluid.

The preferred embodiment of this invention consists of a short pre-analysis chamber, in which the sheath is delivered aligned with the axis of the flowcell (for example, through two opposed ports), an analysis chamber with a wide (1 mm) flow channel, and a nozzle through which the flow stream is discharged to air at the downstream end of the analysis section. In the preferred embodiment, a solid stream of fluid is diverted by a switchable fluid stream (e.g. gas), which is turned off to dispense a particle. Although a large number of different viscosity-increasing agents can be used in the present invention the preferred agent is polyvinyl pyrollidone (PVP). This material can be effectively used over a considerable range of solution concentrations and molecular weight compositions. For example, a 5% by weight solution of a polymer with a 40,000 average molecular weight is effective. Increasing the molecular weight of the polymer generally increases viscosity so that lower concentrations can be used. An ideal solution is a 0.9% by weight solution of a polymer with an average molecular weight of 1.3 million.

### DESCRIPTION OF THE FIGURES

FIG. 1 shows a block diagram of a sorting flow cytometer of the type described in the present invention.

FIG. 2 is a sectional view of a simple flow cell with the boundary layers shown to describe the development of laminar flow.

FIG. 3 is an enlargement of detail ‘3’ from FIG. 2, showing the pre-analysis section of the flowcell near the sheath inlet.

FIG. 4 is an enlargement of detail ‘4’ from FIG. 2, showing the flowcell exit with a droplet forming.

FIG. 5 is a detail from FIG. 4 and shows a control volume for the droplet.

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a method for increasing the size of particles analyzed and the overall rate of particle analysis in a hydro-dynamically focussed flow cytometer by increasing the viscosity of the instrument's sheath reagent.

In a flow cytometer, sheath and sample fluids are introduced into a flowcell in a pre-analysis section. The sheath fluid forms a fully developed laminar flow profile within a short flow length (the entry length), and the sample fluid is injected into the center of this flow profile. The sample fluid, containing a single file sequence of particles to be analyzed is kept centered in the flow channel by the laminar sheath flow, and is analyzed as it passes through an “interrogation” station (sensing zone) such as a laser beam traversing the flowcell, combined with one or more optical detectors.

The laser beam strikes the sample particles one by one as they pass through the interrogation station at a constant velocity. Light scattered and emitted by each particle is detected by a series of optical detectors whose outputs are data that describe the optical characteristics of the analyzed particle. Because the sample particles are all centered, each particle shows a similar optical interaction with the laser beam. In the case of elongate multicellular organisms the centering process also aligns the long axis of the organism with the direction of flow. If the particles move from side to side as they pass through the laser beam, the detector data would be spurious due to fluctuations introduced by such random movement.

If, for some reason, the sheath flow has not fully developed into a laminar flow before the sample particles reach the laser beam, random oscillations may develop in the fluid, and in general, once any such oscillations have begun they will not spontaneously be damped out. These instabilities destroy the measurement precision of the instrument. As discussed below, the pre-analysis region of the flowcell can be increased to allow more length for a stable flow to develop. However, other factors militate against this approach. The present inventors have found that increasing the viscosity of the sheath fluid dramatically decreases the length required to stabilize the flow.

From the pre-analysis chamber or region, the flow passes into the analysis chamber or region of the flowcell, where the particles are measured and analyzed. The rate at which the particles pass through the flowcell depends on the velocity of the fluid flow, which in turn depends on the flow rate. Unfortunately, flow rate cannot always be increased to increase the rate of particle analysis because above a certain velocity, the flow in the analysis chamber becomes unstable, laminar flow is lost and accurate measurements can no longer be made. The present inventors have shown that increasing the viscosity of the sheath fluid increases the velocity at which the transition to unsteady flow occurs.

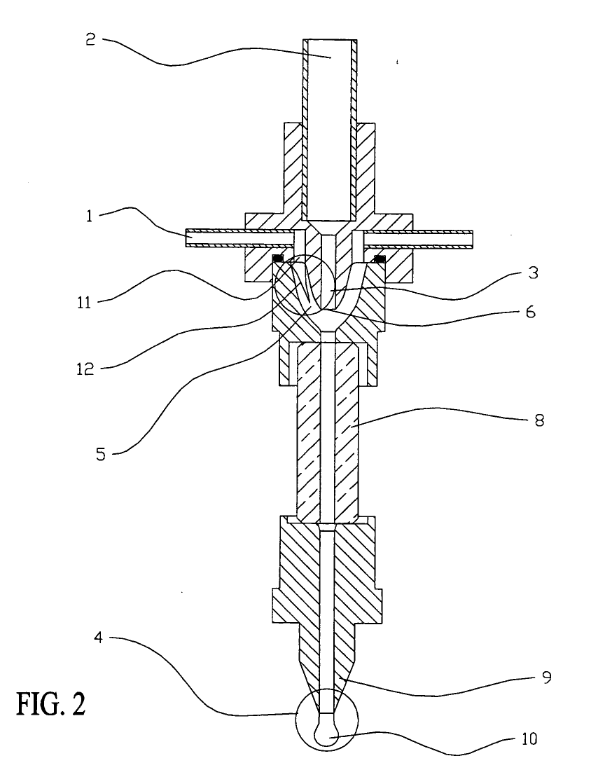

FIG. 2 shows a diagrammatic representation of a flowcell similar to one described by Shapiro (Shapiro Howard M. “Practical Flow Cytometry 3rd ed.”, 1995 Wiley-Liss, Inc. New York, p. 120). Sheath fluid enters through a sheath inlet tube 1 and enters the pre-analysis section of the cell through an orifice 11. Sample fluid enters through a sample injector tube 2 and is injected into the center of the sheath flow through a second orifice 6. The sheath fluid develops boundary layers 12 extending from the inside chamber wall and the outside wall of the sample injector tube 2. The boundary layers converge at a point 5. After the sample injection, the flow converges and flows through an analysis section 8 of the cell, shown here as a quartz capillary. The fluid exits the cell at a nozzle tip 9 and may form into a droplet 10 as shown or a solid stream in air (not illustrated) depending on the flow rates as discussed below.

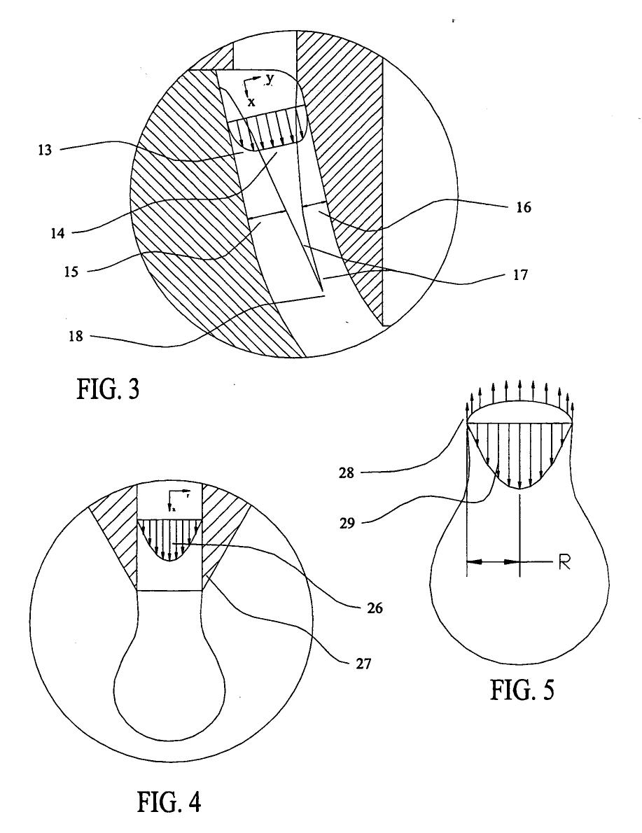

FIG. 3 shows a close-up view of the boundary layers 17 to illustrate the development of laminar flow as discussed below. The boundary layers are areas of viscous flow growing from the walls of the cavity, surrounding an area of inviscid flow 14 at the center. The overall velocity profile is shown at an arbitrary point as 13. Brodskey (Brodskey Robert S. “The Phenomena of Fluid Motions”, 1995 Dover Publications Inc. Mineola N.Y.,p. 120) gives an equation for a boundary layer growing on a flat plate as having the form:

$$δ = K \sqrt{\frac{vx}{{U}_{∞}}} \qquad ( 1 )$$

In the flowcell of FIG. 2, boundary layers form simultaneously on both the inner and outer radii of an annular cavity, although the coefficient K will be different for the inner and outer layers, with the inner layer developing less quickly since the wall surface is smaller there. The thickness of the inner boundary layer at some arbitrary value of x is shown as 16, and the thickness of the outer layer as 15. At some point downstream, the boundary layers will converge. This point (18 here) marks the entrance length, the point at which the laminar flow profile in the annulus is fully developed. The thickness of either boundary layer at this point will be determined solely by the values of K for the two layers, represented by the subscripts i and o, and by the gap α. Denoting the entrance length as x=Le,:

$$\frac{{δ}_{i}}{{δ}_{o}} = \frac{{K}_{i}}{{K}_{o}} \\ {δ}_{i} = {δ}_{o} \frac{{K}_{i}}{{K}_{o}} \\ a = {δ}_{i} + {δ}_{o} {\vert}_{x = {L}_{e}} = ( 1 + \frac{{K}_{i}}{{K}_{o}} ) {δ}_{o} {\vert}_{x = {L}_{e}} \qquad ( 2 )$$

Thus either boundary layer thickness is fixed at this point. Using the centerline velocity UCL in place of the free stream velocity U∞, eq. (1) becomes:

$${δ}_{o} = {K}_{o} \sqrt{\frac{v {L}_{e}}{{U}_{CL}}} \\ R \approx a = ( 1 + \frac{{K}_{i}}{{K}_{o}} ) {K}_{o} \sqrt{\frac{v {L}_{e}}{{U}_{CL}}} \\ \sqrt{\frac{v {L}_{e}}{{U}_{CL}}} ∝ R \qquad ( 3 )$$

The centerline velocity will be determined by the flow rate and geometry; generally for a cylindrical chamber:

Q=πU_{CL}R² (4)

Substituting into equation (3) gives

$$\sqrt{\frac{v {L}_{e} {R}^{2}}{Q}} ∝ R \\ L e ∝ \frac{Q}{v} \qquad ( 5 )$$

The condition for stable, laminar flow in the pre-analysis section of the cell is that the point 5, 18 where the boundary layers converge must be upstream of the point 6 where the sample is injected. From this condition, equation (5) dictates that the length of the flowcell must increase in direct proportion to the flowrate through it.

FIG. 4 shows a small droplet forming on the exit nozzle 27, along with the velocity profile inside the nozzle. FIG. 5 shows a control volume consisting of the droplet, with one entrance plane cutting across the tip of the outlet nozzle 27.

Inside the exit nozzle 27, the flow will exhibit the traditional parabolic laminar flow profile 26; from Brodskey (p.90) the steady-state is:

$$U ( r ) = {U}_{CL} ( 1 - \frac{{r}^{2}}{{R}^{2}} ) \\ {U}_{CL} = 2 \overline{U} \\ \overline{U} ≡ \frac{Q}{A} \qquad ( 6 )$$

where U_{CL} is the centerline velocity and R is the radius of the tube. This will be the profile 29 as the fluid crosses the entrance plane of the droplet.

The sum of forces obeys Newton's second law; taking force in the +x direction to be positive,

$$\sum F = \frac{ⅆ}{ⅆ t} p \\ \sum F = W + {F}_{ST} ≡ J \qquad ( 7 )$$

where W is the weight of the droplet, FST is the force 28 exerted across the entrance plane by the surface tension, and J is the momentum flux into the droplet across the entrance plane.

By taking the moment when the droplet begins to form, the weight will be negligible. The momentum flux term can be found by integrating the differential momentum across the capillary:

$$J = {\int }_{A}^{} ⅆ j ( r ) \\ j ( r ) = \frac{ⅆ}{ⅆ t} ( m U ( r ) ) = n \& U ( r ) \\ dj ( r ) = U ( r ) dn \& = ρ {U}^{2} ( r ) dA \qquad ( 8 a )$$

Putting the equation in cylindrical coordinates,

dj(r)=ρU²(r)rdrdθ (8b)

and substituting the velocity profile from equation (6) gives:

$$dj ( r ) = 4 ρ {{\overline{U}}^{2} ( 1 - {( \frac{r}{R} )}^{2} )}^{2} rdrd θ \\ dj ( r ) = 4 ρ {\overline{U}}^{2} ( 1 - 2 \frac{{r}^{3}}{{R}^{2}} + \frac{{r}^{5}}{{R}^{4}} ) dr d θ \qquad ( 8 c )$$

Integrating across the nozzle and substituting the volume flow rate Q from equation (6) gives:

$$J = 4 ρ \overline{U} {\int }_{0}^{2 π} {\int }_{0}^{R} ( 1 - 2 \frac{{r}^{3}}{{R}^{2}} + \frac{{r}^{5}}{{R}^{4}} ) ⅆ r ⅆ θ \\ J = 8 π ρ {{\overline{U}}^{2} [ \frac{{r}^{2}}{2} - \frac{{r}^{4}}{2 {R}^{2}} + \frac{{r}^{6}}{6 {R}^{4}} ]}_{0}^{R} \\ J = \frac{4}{3} π ρ {\overline{U}}^{2} {R}^{2} = \frac{4 ρ}{3 π {R}^{2}} {Q}^{2} \qquad ( 9 )$$

Substituting J into equation (7), and taking the definition of the surface tension F=PY where F is the force exerted, P is the length of the cut surface, and Y is the surface tension:

$$2 π RY = \frac{4 ρ}{3 π {R}^{2}} {Q}^{2} \\ Q = \sqrt{\frac{3 {π}^{2} {R}^{3} Y}{2 ρ}} \\ Q = \frac{π}{4} \sqrt{3 {d}^{3} \frac{Y}{ρ}} \qquad ( 10 )$$

Thus, the rate of flow required to sustain a “solid” stream of fluid in air is directly related to the diameter of the flow channel. Recall that such a solid stream is a prerequisite for the fluid switch sorting arrangement. When the exit nozzle from the flowcell‘is only 0.25 mm in diameter, a flow rate of approximately 2.5 ml/min is needed to ensure a solid stream. When the nozzle is increased four fold to 1 mm, the required flow rate goes up eight fold to approximately 20 mL/min. When the nozzle is increased to 2 mm (an eight-fold increase), the flow rate increases to approximately 50 mL/min, a twenty-fold increase.

At a fixed nozzle size, alteration of viscosity has no effect on the minimum flow rate. However, many viscosity-altering agents also change the surface tension of the liquid. The minimum flow rate varies as the 1.5 power of the nozzle diameter and as the 0.5 power of the fluid's surface tension. At a given nozzle size, the maximum flow rate for stable flow inside the flowcell increases linearly with increasing viscosity. At the same time the minimum flow rate for a solid exit stream varies with the square root of the surface tension of the fluid.

Thus, if a given agent doubles the viscosity and doubles the surface tension, the maximum stable flow rate will double while the minimum solid flow rate will increase by 41%. For instance, 5% (by weight) PVP (40,000 MW) gives an increase of 180% in the viscosity and apparent increase of 125% in the surface tension. This nearly triples the flow rate at which stable laminar flow is possible but only increases the minimum solid flow rate by about 50%.

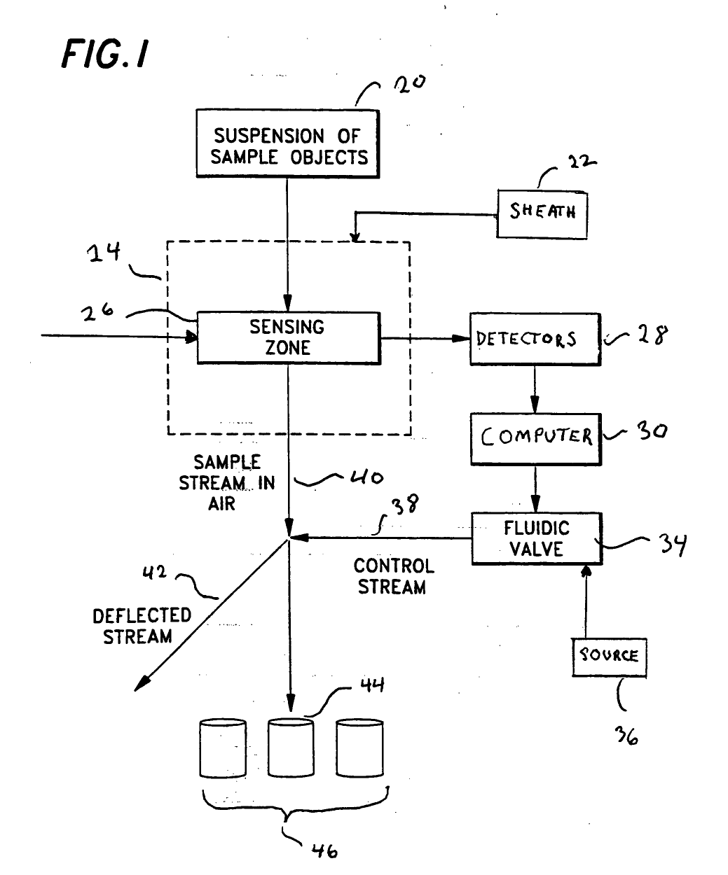

In the preferred design for a 1 mm flow channel flow cell (FIG. 1) the maximum laminar flow rate is 14 mL/min, but the minimum rate for a solid exit stream is 20 mL/min. By adding PVP (either 5% by weight of 40,000 MN or 0.9% of 1.3 million MW), the maximum stable flow rate increases to over 40 mL/min while the minimum rate for a solid exit stream increases to 29 mL/min. That is, increased viscosity results in a higher laminar flow rate. However, viscosity altering agents often increase the fluid surface tension, which results in an increase in the minimum flow rate necessary to sustain a solid flow stream. Because the viscosity effect is linearly related whereas the surface tension effect is related as the square root, a given viscosity-altering agent may actually render a given flowcell design useable where the same design would not operate at all with water.

With too short an entrance length (Lₑ), or too high a flow rate, the flow will not be fully stabilized when it reaches the laser beam. If the flow is unstable, the cytometer performs poorly because the optical measurements are inexact. If one increases V in order to get, in the case of a solid stream in air system, the nozzle to emit a solid fluid stream in air, one has to increase Lₑ proportionately to ensure that flow at the laser beam is laminar. Such an approach results in a rapid increase in the entry length of the flowcell. For all practical purposes this results in an instrument with an excessively long flowcell which may be difficult to construct or accommodate.

The calculations show the usefulness of increasing the sheath viscosity even when increasing the diameter of the flowcell is not desired. Using a crude approximation one sees that increasing v by a factor of 2, while leaving D and Le the same (i.e., leaving the geometry of the flowcell unchanged), one can increase V (approximately by a factor of 2 as well). So, for the same sample dilution (which has been set to prevent clogging and coincident particles), one can run twice as many particles per second without sacrificing laminar flow. On the contrary if one tries to increase V without increasing the viscosity or altering the flowcell geometry, the flow becomes unstable.

Increased viscosity can be achieved with any number of additives dissolved in water, including polyvinyl pyrollidone (PVP), polyethylene glycol (PEG), polyvinyl alcohols, polyvinyl acetals, polyacrylic acids, polyacrylamides, plant gums (such as gum acacia and gum tragacanth), cellulose ethers (carboxymethyl cellulose), celluloses, hemicelluloses, dextrans, inulins, sucrose and other carbohydrates (monosaccharides, oligosaccharides and polysaccharides). Non-aqueous fluids (glycerol, propylene glycol, etc.) can also be used to increase viscosity as long as they are water miscible. Generally, biological objects require a medium that is at least partially aqueous. For analysis of non-biological objects the fluids can be completely non-aqueous.

This invention is an improvement over current flow cytometry methods because it allows the flow cell channel to be enlarged without impairing other functions of the instrument. With water or biological saline as the sheath, use of a larger channel requires a decrease in the velocity at which the samples pass through the flowcell to ensure laminar flow, thereby limiting speed. A larger channel also requires that the pre-analysis chamber or region be elongated to allow a sufficient distance for the sheath fluid to develop a steady laminar flow. The current invention allows the use of a larger flow channel without any increase in the length of the pre-analysis chamber or decrease in fluid velocity.

Furthermore, the high-viscosity sheath reagent can be used to increase the analysis rate in a standard flow cytometer. Instead of running particles through a larger flow channel at the same velocity, particles can be run through the same flow channel at a higher velocity.

This invention is especially useful for systems which require that the stream exit into air as a solid stream and not as droplets. If the flow rate is too slow, the stream will form droplets and dribble from the exit nozzle. However, when the flow rate is increased to ensure formation of a solid stream, laminar flow in the flowcell may be lost unless the entry length is increased. As explained above, this entire problem is greatly exacerbated when the flow channel diameter is increased to accommodate elongated multicellular organisms. The use of high-viscosity sheath allows these systems to be run at a sufficiently high flow rate that the fluid exits the nozzle as a solid stream rather than as drops without impairing laminar flow.

One further advantage of the high-viscosity sheath fluid is that large particles often settle out of the sample fluid being analyzed before it reaches the flowcell. Increased viscosity of the sample fluid slows the rate at which the particles settle, making mixing of the samples easier and preventing settling in the sample lines. However, it should be kept in mind that if light scatter is used to detect and measure the particles, the sheath and sample fluid must have the same refractive index or the sample fluid will scatter light even when no particle is present. This means that modification of sheath viscosity will normally require a similar modification of the sample fluid so that the indices of refraction match.

Because the sample fluid often requires the same or similar modification as the sheath fluid some attention must be paid to the osmotic effects of the viscosity-modifying agent. Although sucrose, glycerin and other low molecular weight compounds can be employed for viscosity modification, such materials will often have a significant osmotic effect at concentrations sufficient to significantly alter the viscosity. In the case of biological samples excess osmoticum can distort the samples and even lead to a loss of viability. Therefore, it is preferred to use agents with a higher molecular weight, such as PEG polymers, PVP polymers or carbohydrate polymers. With such agents a significant increase in viscosity can be achieved with only a negligible increase in osmotic strength.

A potential drawback to the viscosity-increasing agents is that they generally increase the surface tension of the fluid. This requires a higher flow rate to ensure formation of a solid stream in air. However, because the surface tension effect is related to the square root of the surface tension increase while the velocity change in achieving laminar flow is linearly related to the increase in viscosity, with many agents the improvement due to viscosity increase more than outweighs the problems caused by an increase in surface tension. Nevertheless, when selecting a viscosity-increasing agent, one should select agents that cause the largest increase in viscosity on a mole per mole basis while causing the smallest increase in surface tension on a molar basis. Generally high molecular weight polymers will cause the greatest increase of viscosity on a molar basis. These same polymers are also the most likely to be nontoxic to organisms because such large polymers are unable to penetrate cell membranes. Other factors being equal, agents with the smallest molar effect on surface tension should be selected. Hydrophilic polymers such as PVP are known to show some surfactant activity and cause a smaller increase in surface tension. However, because of the mathematical relationships explained above, especially favorable viscosity and toxicity properties can often outweigh unfavorable surface tension properties.

Currently a preferred sheath and sample fluid contain about 0.9% by weight PVP having a molecular weight of about 1.3 million. When used to analyze and/or sort multicellular animals, testing of potential new drug compounds is a preferred use of the current invention. Therefore, long- term viability of the analyzed organisms is key. The present inventors have tested the viability of Drosophila melanogaster larvae in both 5% PVP (40,000 MW) and 0.9% PVP (1.3 million MW) as well as a variety of concentrations and molecular weights between these figures and have found little, if any toxicity. This is hardly surprising since PVP use is allowed in a large number of food and medical products ranging from beer to hair preparations to eye drops. PVP has been even used as a substitute for human plasma. The overall viability exceeded 95% even after aerating the embryos for 8 hours in PVP with an antifoaming agent. When the embryos are “dechorionated” by treatment in bleach, viability in PVP still exceeded 85%

The following claims are thus to be understood to include what is specifically illustrated and described above, what is conceptually equivalent, and what can be obviously substituted. Those skilled in the art will appreciate that various adaptations and modifications of the just- described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A method for maintaining laminar flow in a flow cytometer flow chamber comprising adding a viscosity-increasing agent to a fluid flowing through said flow chamber.

2. The method of claim 1, wherein the viscosity-increasing agent is a water-soluble organic polymer with an average molecular weight between 10,000 and 10,000,000.

3. The method of claim 2, wherein the water-soluble organic polymer has an average molecular weight of at least 1,000,000.

4. The method of claim 2, wherein the water-soluble organic polymer is selected from the group consisting of polyvinyl pyrollidone, polyethylene glycols, polyvinyl alcohols, polyvinyl acetals, polyacrylic acids, polyacrylamides, plant gums, cellulose ethers, celluloses, hemicelluloses, dextrans, inulins, oligosaccharides and polysaccharides.

5. The method of claim 1, wherein the viscosity-increasing agent is selected to minimize increases in surface tension of the fluid.

6. The method of claim 1, wherein the viscosity-increasing agent is selected to minimize increases in osmotic strength of the fluid.

7. The method of claim 1, wherein the fluid is one of sheath fluid, or both sheath fluid and sample fluid.

8. A sorting flow cytometer of the type where elongate multicellular organisms are passed through a flow cell and the organisms are subsequently sorted from a solid fluid stream in air by a controlled diverting fluid stream characterized in that a length of the flow cell is decreased and flow rate of a fluid through the flowcell is increased by adding a viscosity-increasing agent to the fluid flowing through the flowcell.

9. The sorting flow cytometer of claim 8, wherein the viscosity-increasing agent is a water-soluble organic polymer with an average molecular weight between 10,000 and 10,000,000.

10. The sorting flow cytometer of claim 9, wherein the water-soluble organic polymer has an average molecular weight of at least 1,000,000.

11. The sorting flow cytometer of claim 9, wherein the water-soluble organic polymer is selected from the group consisting of polyvinyl pyrollidone, polyethylene glycols, polyvinyl alcohols, polyvinyl acetals, polyacrylic acids, polyacrylamides, plant gums, cellulose ethers, celluloses, hemicelluloses, dextrans, inulins, oligosaccharides and polysaccharides.

12. The sorting flow cytometer of claim 8, wherein the viscosity-increasing agent is selected to minimize increases in surface tension of the fluid.

13. The sorting flow cytometer of claim 8, wherein the viscosity-increasing agent is selected to minimize increases in osmotic strength of the fluid.

14. The sorting flow cytometer of claim 8, wherein the fluid is one of sheath fluid, or both sheath fluid and sample fluid.
